(19) United States
(12) Patent Application Publication
(10) Pub. No.: US 2008/0188114 A1
(43) Pub. Date: Aug. 7, 2008

(54) Connector With A Lever

(76) Inventors: Chul-Sub Lee, Daegu (KR); Kun-Taek Lim, Kyungsangbuk-Do (KR)

Correspondence Address: BARLEY SNYDER, LLC, 1000 WESTLAKES DRIVE, SUITE 275, BERWYN, PA, 19312, US

(21) Appl. No.: 12/026,271

(22) Filed: Feb. 5, 2008

(30) Foreign Application Priority Data
Feb. 5, 2007 (KR) 10-2007-11801

(51) Int. Cl. H01R 13/631

(52) U.S. Cl. 439/345

(57) ABSTRACT

A connector having a first connector portion and a lever movably connected to an outside of the first connector portion is disclosed. The lever is rotatable with respect to the first connection portion and the lever is translatable with respect to the first connection portion. A guide projection is connected to the lever and the connector further has a second connector portion. The second connector portion has a guide channel having an open upper part, at least a portion of the guide channel having a sloped portion being sloped with respect to a direction in which the first connector portion is connectable to the second connector portion, the guide channel configured to receive the guide projection through the open upper part of the guide channel.

### CROSS-REFERENCE TO RELATED APPLICATIONS

This application claims the benefit of the previously filed Korean Patent Application No. 10-2007-0011801 that has a filing date of Feb. 5, 2007.

### FIELD OF THE INVENTION

The present invention relates to a connector.

### BACKGROUND

Generally, an electrical connector functions to electrically connect separate parts of a circuit. Electrical connectors often comprise a cap and a plug as a pair. Electrical connectors are widely used to supply electric power to various machines and electronic appliances. Electrical connectors are also used to intermittently connect various electric operation signals with one another.

However, when connecting the cap to the plug of a conventional connector, an operator has to grip the cap and the plug using both hands and apply a great force to the cap and the plug in opposite directions. Therefore, connection of the cap and the plug is sometimes very laborious, especially when doing so within the confines of a small space.

To solve such problems, a lever connector has been introduced that forcibly connects a cap and a plug of the lever connector with each other by pivoting a lever that is mounted to the connector. In such a conventional lever connector, however, since the lever is pivotable in one direction, and enough space for the pivoting of the lever is required, a length of the lever is necessarily increased.

### SUMMARY

The present invention relates to, in one embodiment among others, a connector having a first connector portion and a lever movably connected to an outside of the first connector portion. The lever is rotatable with respect to the first connection portion and the lever is translatable with respect to the first connection portion. A guide projection is connected to the lever and the connector further has a second connector portion. The second connector portion has a guide channel having an open upper part, at least a portion of the guide channel having a sloped portion being sloped with respect to a direction in which the first connector portion is connectable to the second connector portion, the guide channel configured to receive the guide projection through the open upper part of the guide channel.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an oblique view of a connector according to an embodiment of the present invention;

FIG. 2 is an orthogonal view of the connector of FIG. 1 before assembly;

FIG. 3 is an orthogonal view of the connector of FIG. 1 during assembly; and

FIG. 4 is an orthogonal view of the connector of FIG. 1 after assembly.

### DETAILED DESCRIPTION OF THE EMBODIMENTS

Hereinafter, an exemplary embodiment of the present invention will be described in detail with reference to the accompanying drawings.

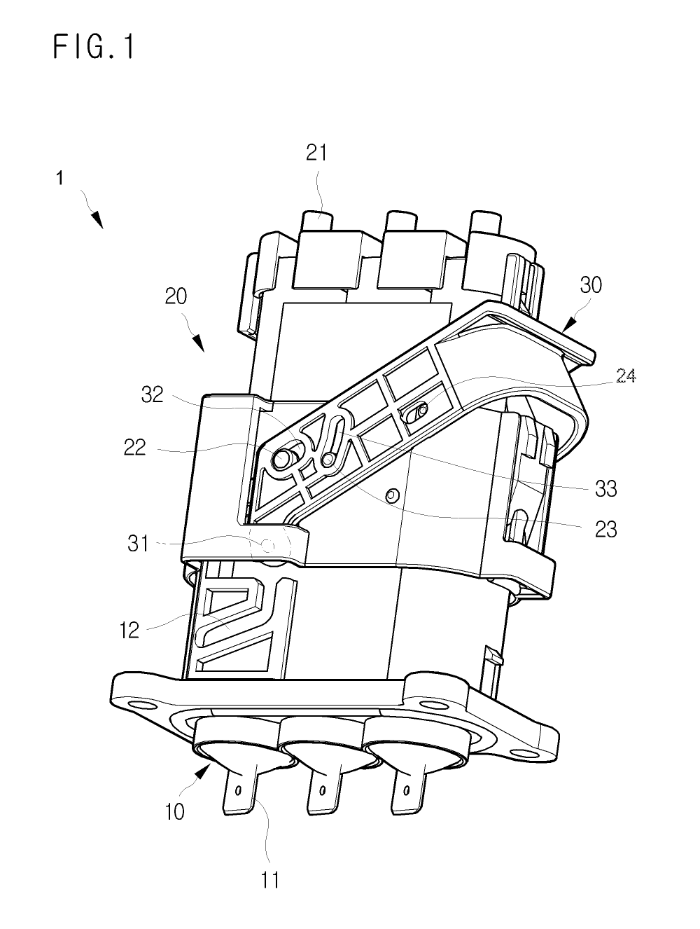

Referring to FIG. 1, a connector 1 according to an embodiment of the present invention comprises a first connector portion 10 and a second connector portion 20 that are connected to each other, thereby supplying power or connecting electric signals. The connector 1 further comprises a lever 30 for pivoting that is mounted to an outside of the second connector portion 20. The connector 1 can be easily assembled with minimal force using the principle of leverage, more specifically, by forcibly connecting the first connector portion 10 with the second connector portion 20 by pivoting operation of the lever 30.

The first connector portion 10 comprises a first terminal 11 formed at one end thereof for connection with a circuit board or a cable, and a guide channel 12 formed on an outer surface thereof to be engaged with the lever 30 so that the first connector portion 10 is introduced into the second connector portion 20 by pivoting the lever 30.

The second connector portion 20 supplies power or connects electric signals through connection with the first connector portion 10. The first connector portion 10 is inserted in and engaged with the second connector portion 20. The second connector portion 20 comprises a second terminal 21 at one end for connection with the circuit board or the cable to be supplied with the power or the electric signals, and first shafts 22 formed at opposite positions on an outer surface of the second connector portion 20 for the lever 30 to be hinged upon.

The lever 30 is hinged on the outside of the second connector portion 20 to pivot vertically with respect to the second connector portion 20, thereby forcing the first connector portion 10 into the second connector portion 20. For this operation, the lever 30 comprises first apertures 32 engaged with the first shafts 22, and a guide projection 31 formed to be projecting inwardly at a lower part of the first aperture 32 to be engaged with the guide channel 12 of the first connector portion 10.

The guide channel 12 is recessed from the outer surface of the first connector portion 10 and open at the upper part thereof in a state where the lever 30 is maximally lifted, such that the guide projection 31 can be conveniently engaged with the guide channel 12. In addition, the guide channel 12 is sloped downward in a direction opposite to the lever 30. Therefore, the guide projection 31 is slid into the guide channel 12 by leverage with respect to the first shafts 22.

The lever 30 further comprises second apertures 33 formed on lateral sides of the lever 30 in a longitudinal direction corresponding to a pivoting motion of the lever 30. In addition, a second shaft 23 is formed on the outer surface of the second connector portion 20 and inserted in a second aperture 33. The first aperture 32 is in the form of slot allowing the lever 30 to move horizontally with respect to the second connector portion 20.

According to this structure, when the lever 30 pivots vertically relative to the second connector portion 20, the lever 30 is also able to move horizontally depending on positions thereof. Therefore, a moving distance of the guide projection 31 can be maximized in proportion to a pivoting angle of the lever 30. Consequently, a length of the lever 30 can minimized, thereby reducing the overall size of the connector 1.

The second connector portion 20 further includes upper and lower lock projections 24 formed on the outer surface at positions corresponding to a highest position and a lowest position of the lever 30, respectively. The lever 30 includes a third aperture 34 for receiving the lock projections 24 therein so as to secure the lever 30 at the highest position and the lowest position, thereby preventing disassembling of the connector 1 by an external impact applied to the lever 30. Preferably, movement of the lever 30 is prevented to avoid deviation between the guide channel 12 and the guide projection 31, during assembling of the connector 1.

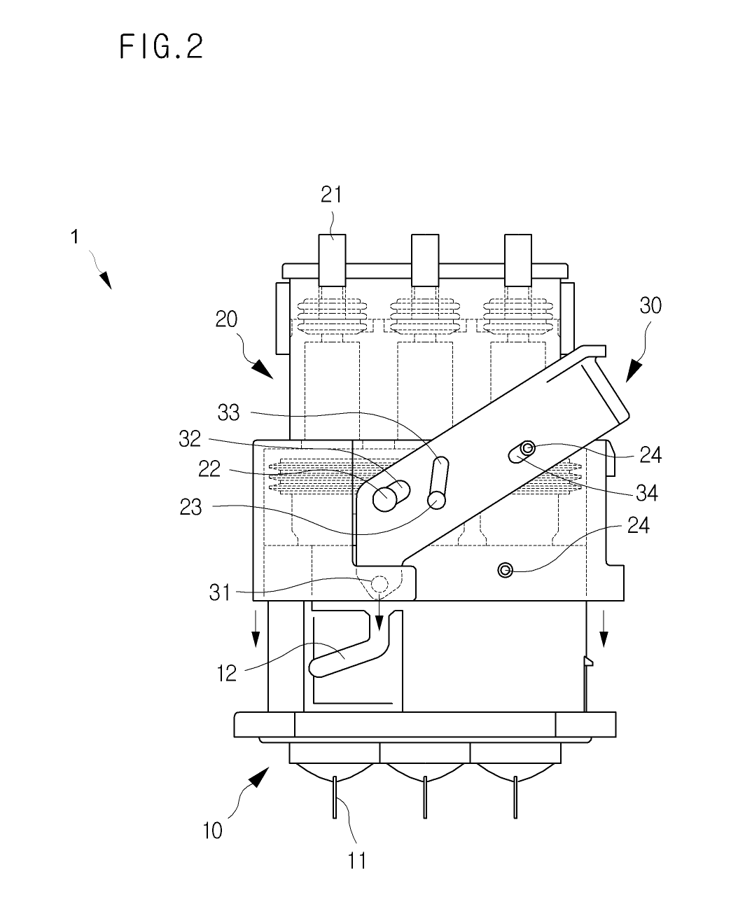

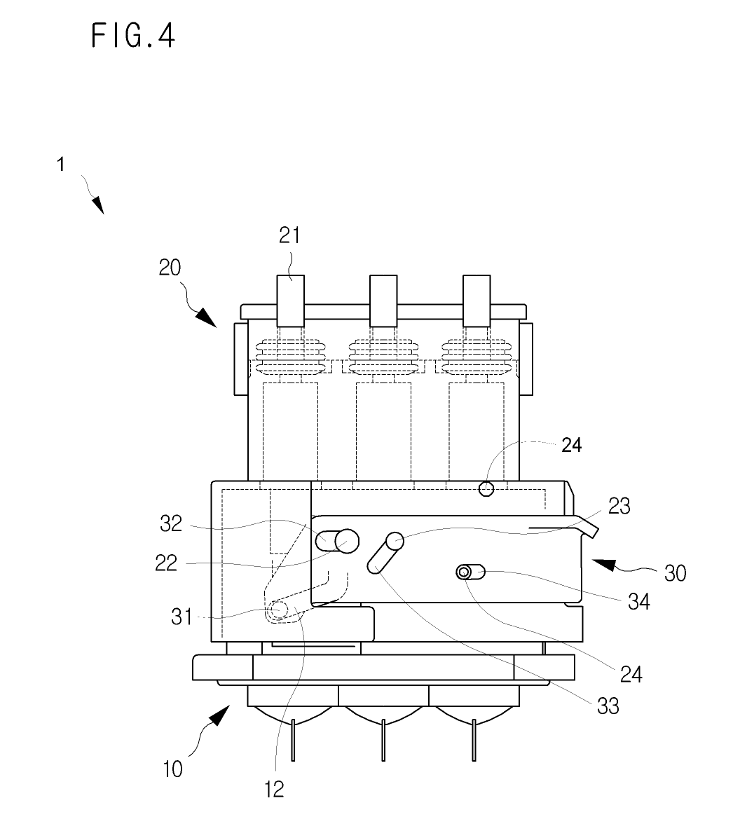

FIGS. 2-4 show the operation of the connector 1 according to the embodiment of the present invention. When connecting the first connector portion 10 and the second connector portion 20, which are separated, to each other, the lever 30 is lifted to the highest position as shown in FIG. 2, thereby engaging the upper lock projection 24 with the third aperture 34. In this state, the lever 30 is prevented from pivoting downward by gravity.

In this state, since the lever 30 is moved outward relative to the second connector portion 20 by pivoting, the guide projection 31 is maintained at a position corresponding to the open part of the guide channel 12. When the first connector portion 10 and the second connector portion 20 are pushed toward each other, the guide projection 31 is inserted in the guide channel 12, hence completing a primary step of assembling connector 1.

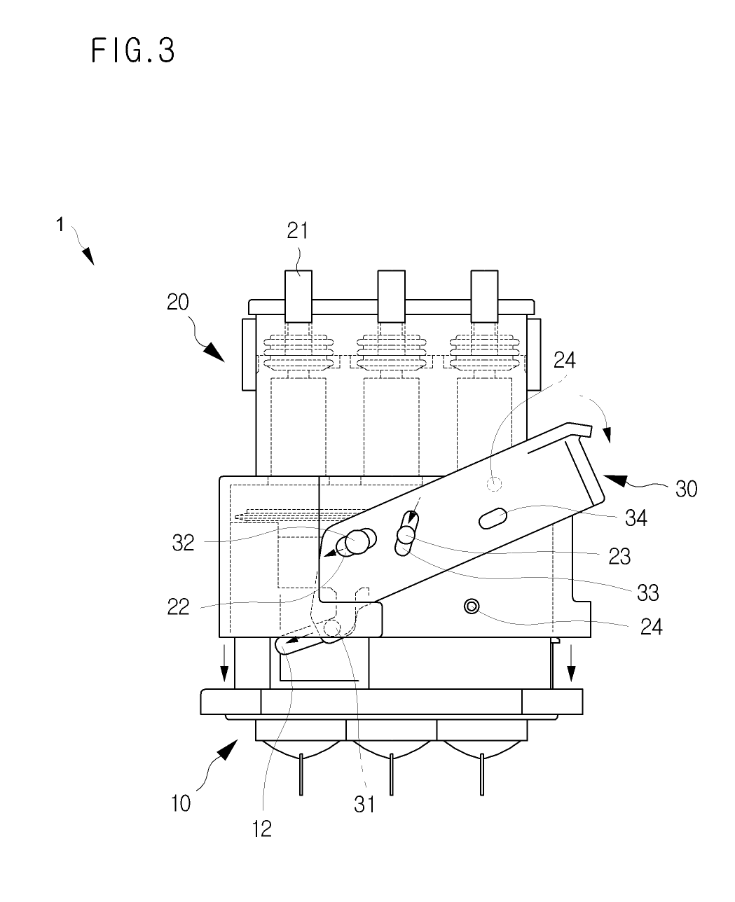

Next, when the lever 30 is pivoted as shown in FIG. 3, the lever 30 moves down, maintaining engagement between the second shaft 23 and the second aperture 33, thereby moving toward the second connector portion 20. Simultaneously, as the guide projection 31 moves along the guide channel 12, the first connector portion 10 is pulled into the second connector portion 20.

When being pivoted down to the lowest position, the lever 30 is fully moved toward the second connector portion 20. Simultaneously, the guide projection 31 is inserted up to an inner end of the guide channel 12, thereby completely connecting the first connector portion 10 and the second connector portion 20 to each other so that the power supply connection or the signal connection is accomplished.

After the lever 30 is pivoted down to the lowest position, the third aperture 34 of the lever 30 is fixed by engagement with the lower lock projection 24 of the second connector portion 20 so that the lever 30 is not affected by an external impact or the like. Accordingly, undesired separation of the first connector portion 10 from the second connector portion 20 is prevented.

As apparent from the above description, the present invention provides a connector 1 capable of forcibly connecting a first connector portion 10 and a second connector portion 20 with each other through a pivoting operation of a lever 30 mounted to the first connector portion 10. According to the present invention, assembly of the connector 1 can be achieved even with minimal force since the first connector portion 10 and the second connector portion 20 are easily connected by the principle of leverage of the lever 30 even though the connector 1 includes a plurality of first and second terminals 11 and 21. Furthermore, since a length of the lever 30 can be reduced, the overall size of the connector 1 can be minimized, while maximizing a moving distance of the connector 1.

The connector 1 according to the present invention enables both vertical and horizontal movements of the lever 30 relative to the first connector portion 10, by comprising first apertures 32 and second apertures 33 formed on the lever 30. As a result, the structure of the connector 1 is simplified, further simplifying the manufacture of the connector 1. Further, assembly and disassembly of the connector 1 can be performed more precisely.

Moreover, since the lever 30 is fixed at highest and lowest positions thereof by third apertures 34 and lock projections 24, undesired movement of the lever 30 is prevented before assembly of the connector 1. Consequently, more precise assembly is achieved while preventing failure in connection due to movement of the lever 30 after assembly.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A connector, comprising:
a first connector portion;
a lever movably connected to an outside of the first connector portion, the lever being rotatable with respect to the first connection portion and the lever being translatable with respect to the first connection portion,
a guide projection connected to the lever;
a second connector portion having a guide channel having an open upper part, at least a portion of the guide channel having a sloped portion being sloped with respect to a direction in which the first connector portion is connectable to the second connector portion, the guide channel configured to receive the guide projection through the open upper part of the guide channel.

2. The connector according to claim 1, wherein movement of the guide projection into the guide channel through the open upper part of the guide channel promotes connection of the first connector portion to the second connector portion.

3. The connector according to claim 1, further comprising:
a first shaft connected to the first connector portion; and
a first aperture formed in the lever and configured to receive the first shaft.

4. The connector according to claim 3, wherein the first aperture is elongated and allows translation of the first shaft with respect to the lever.

5. The connector according to claim 4, further comprising:
a second shaft connected to the first connector portion; and
a second aperture formed in the lever and configured to receive the second shaft.

6. The connector according to claim 5, wherein the second aperture is elongated and allows translation of the second shaft with respect to the lever.

7. The connector according to claim 6, wherein the first aperture is substantially linearly elongated.

8. The connector according to claims 6, wherein the second aperture is substantially linearly elongated.

9. The connector according to claim 6, further comprising:
a lock projection connected to the first connector portion; and
a third aperture formed in the lever and configured to receive the lock projection.

10. The connector according to claim 9, wherein the lock projection is located on the first connector portion so that the lever is in a highest position with respect to the first connector portion when the lock projection is located within the third aperture.

11. The connector according to claim 10, wherein when the lock projection is located within the third aperture, the guide projection is aligned with the open upper part of the guide channel for entry into the guide channel by substantially linearly moving the first connector portion toward the second connector portion.

12. The connector according to claim 9, wherein the lock projection is located on the first connector portion so that the lever is in a lowest position with respect to the first connector portion when the lock projection is located within the third aperture.

13. The connector according to claim 12, wherein when the lock projection is located within the third aperture, the guide projection is located within the sloped portion of the guide channel.

14. The connector according to claim 5, wherein movement of the guide projection into the guide channel through the open upper part of the guide channel promotes connection of the first connector portion to the second connector portion.
